(19) United States
(12) Patent Application Publication
(10) Pub. No.: US 2026/0359455 A1
(43) Pub. Date: Nov. 12, 2026

(54) SYSTEMS AND METHODS FOR BIOMETRIC GATING OF EXECUTION CONTROL AND DATA PROTECTION

(71) Applicant: DAVID A GRANZOTTI, CARY, NC (US)

(72) Inventor: DAVID A GRANZOTTI, CARY, NC (US)

(21) Appl. No.: 19/671,891

(22) Filed: May 8, 2026

Related U.S. Application Data
(60) Provisional application No. 63/802,318, filed on May 8, 2025.
(60) Provisional application No. 63/802,804, filed on May 9, 2025.

(51) Int. Cl. G06F 21/60; G06F 21/62

(52) U.S. Cl. CPC G06F 21/602; G06F 21/62

(57) ABSTRACT

A user may utilize one or more devices configured to capture a biometric signal comprising one or more transient physiological responses. The user may perceive or recall a stimulus, which may evoke a physiological response that may vary based on cognitive, emotional, or environmental state. A real-time biometric response may be processed to derive an entropy fingerprint that may be used to gate one or more cryptographic or computational operations, including decryption, reconstruction, segmentation reversal, or execution. Access to protected data or operations may be conditionally permitted only when the derived entropy fingerprint satisfies one or more entropy-conditioned gating criteria. Because the biometric signal and resulting entropy fingerprint may be non-deterministic and session-dependent, possession of encrypted data, cryptographic keys, entropy sources, metadata, or distributed fragments alone may be insufficient to permit access absent satisfaction of the required entropy-conditioned gating criteria.

### CROSS-REFERENCES TO RELATED APPLICATIONS

This application claims the benefit of: (i) U.S. Provisional Application No. 63/802,804, filed May 9, 2025, entitled “SYSTEMS AND METHODS FOR BIOMIMETICALLY-GATED ENCRYPTION AND DATA PROTECTION USING PUPILLOMETRY-BASED ENTROPY”; and (ii) U.S. Provisional Application No. 63/802,318, filed May 9, 2025, entitled “SYSTEMS AND METHODS FOR COGNITIVELY-GATED ENCRYPTION AND DATA PROTECTION USING EEG-BASED ENTROPY”, each of which is incorporated herein by reference in its entirety.

### FIELD OF THE DISCLOSURE

The present disclosure relates generally to systems and methods for execution control and data protection that may leverage real-time biometric signals, including but not limited to ocular signals (e.g., pupillometry) and neural signals (e.g., electroencephalography (EEG)), including but not limited to pupillary dilation, blink rate, saccade latency, brainwave activity, frequency-domain characteristics, and other physiological response metrics, as entropy-conditioned gating mechanisms that may control cryptographic state transitions, including enabling or constraining encryption, decryption, data reconstruction, and execution of AI and system operations. The system may generate one or more cryptographic or computational elements from one or more non-deterministic entropy sources, wherein usability, activation, or reconstruction of such cryptographic elements may be conditioned or gated by biometric signals. Execution of one or more cryptographic or computational operations may be gated by real-time biometric signals such that the operations are not performed unless the entropy-conditioned gating criteria are satisfied, thereby preventing execution based solely on possession of data or cryptographic elements. Encryption algorithms may include, but are not limited to, information-theoretic models (e.g. one-time pad) and/or complexity-theoretic systems (e.g. post-quantum cryptography). Decryption and reassembly, if any, may be conditionally permitted based on transient entropy fingerprints derived from live biometric input, without persistent biometric templates or identity-based models. The system optionally supports segmentation of encrypted data and metadata-governed reconstruction, ensuring that access may be computationally and physically infeasible without a valid, real-time biometric signal. In all embodiments, one or more cryptographic or computational elements may be generated independently of the biometric signal, and the biometric signal may be used to condition or gate usability or activation of such elements rather than to deterministically generate such elements. The present disclosure explicitly excludes deterministic, identity-based methods for biometric signals, offering a privacy-preserving, entropy-driven alternative for single-user and group-based secure access.

### SUMMARY

The embodiments described herein are designed to protect a user from a complete and total exfiltration of data and cryptographic elements, even in scenarios where an attacker obtains a full copy of exfiltrated artifacts. During operation, a user may initiate encryption of a file or data object. The system may invoke one or more non-deterministic entropy sources to produce entropy from which one or more cryptographic or computational elements may be generated. A biometric sensing component may capture a biometric signal comprising one or more transient physiological responses while the user perceives or recalls a stimulus. The system may derive a transient entropy fingerprint from the biometric signal and may use the entropy fingerprint to condition, filter, or gate usability of one or more cryptographic or computational elements. The biometric signal may not be used as a deterministic source of entropy for generation of such cryptographic elements, but may instead control whether such elements may be activated or used. The system may store metadata describing entropy characteristics, and may operate without storing raw biometric signals or identity templates. In some embodiments, data may be optionally segmented or structured, and metadata may describe validation logic or reconstruction conditions. During a subsequent access attempt, a user may provide a new live biometric signal comprising one or more transient physiological responses. The system may derive a new entropy fingerprint and compare it to stored metadata. If one or more entropy-conditioned gating criteria are satisfied, the system may permit execution of one or more operations, including decryption, reconstruction, or access to the data object. If such criteria are not satisfied, the system may deny access. Possession of encrypted data, cryptographic elements, entropy sources, or metadata alone may be insufficient to permit access absent satisfaction of the required entropy-conditioned gating criteria.

The present disclosure describes a system in which a biometric signal comprising one or more transient physiological responses may be used to derive an entropy fingerprint that may gate whether one or more cryptographic or computational operations may occur, without reliance on stored biometric templates or deterministic identity verification. The system may use real-time biometric signals as entropy-conditioned gates for cryptographic state transitions and/or reconstruction that may be required for execution. The system may generate cryptographic keys from quantum random number generators or other non-deterministic entropy sources, wherein usability of such keys may be conditioned or gated by transient physiological responses. Data may be encrypted using one or more encryption keys whose usability may be conditioned or gated by a biometric signal. Optionally, data may be: (i) segmented into entropy-balanced fragments; and (ii) paired with a reconstruction key encoding segment lineage and entropy structure, which reconstruction key may be encrypted using a secondary entropy source, wherein usability of such reconstruction key is conditioned or gated by a biometric signal. Decryption may require a live biometric signal satisfying one or more entropy-conditioned gating criteria, without which reconstruction of the key or execution of the decryption operation may not occur, making reconstruction potentially infeasible without real-time biometric signal congruence. The system may store no identity templates and may resist exfiltration, key compromise, and replay, even in post-quantum threat environments.

The present disclosure addresses the need for data security models that may remain secure even when a copy of encryption keys, data, or related materials are compromised. The disclosed system may leverage non-deterministic entropy sources and biometric signals to construct an architecture in which access to cryptographic or computational operations may be conditionally permitted based on entropy-conditioned gating criteria.

In some embodiments, entropy may be obtained from a quantum random number generator or other non-deterministic entropy source. A biometric signal comprising one or more transient physiological responses may be processed to derive an entropy fingerprint that may condition, filter, or gate usability of elements derived from such entropy or any keys, tokens, or data derived therefrom.

The system may derive one or more cryptographic or computational elements, including encryption keys, reconstruction elements, or validation tokens, from entropy obtained from one or more non-deterministic entropy sources, wherein usability of such elements may be conditioned or gated by a biometric signal. The usability of such cryptographic or computational elements may be gated such that one or more operations may only occur when a subsequently derived entropy fingerprint from a biometric signal satisfies one or more similarity or validation conditions relative to stored metadata.

In some embodiments, the system may gate not only access to data, but also the activation, reconstruction, or execution of one or more operations, including decryption, reconstruction, data access, or execution of computational processes. Such operations may be conditionally permitted based on satisfaction of one or more entropy-conditioned gating criteria derived from a biometric signal comprising one or more transient physiological responses.

In some embodiments, one or more operations may include encryption, decryption, data segmentation, data reconstruction, data access, or execution of one or more computational processes. The system may not require deterministic reproduction of a biometric signal, and may instead permit operation based on threshold-based similarity of entropy characteristics derived from transient physiological responses.

During a subsequent access attempt, a new biometric signal comprising one or more transient physiological responses may be captured and processed to derive a new entropy fingerprint. The system may compare the new entropy fingerprint to previously stored metadata describing entropy characteristics. If one or more similarity conditions are satisfied, the system may permit reconstruction or activation of one or more cryptographic or computational elements, thereby allowing the requested operation to proceed. If such conditions are not satisfied, the system may deny the operation.

The system may operate without storing raw biometric signals, identity templates, or deterministic biometric representations. Instead, the system may store metadata describing entropy characteristics sufficient to evaluate similarity without enabling reconstruction or identification of a user.

The present disclosure may be implemented in classical systems, quantum, hybrid quantum-classical systems, or other architectures in which entropy sources and biometric conditioning may be combined. In some embodiments, entropy fingerprints derived from biometric signals may influence gating decisions, selection logic, or validation conditions applied to elements derived from entropy sources, without influencing generation of such entropy or cryptographic or computational elements.

Because the biometric signal may be non-deterministic and session-dependent, and because the system may gate usability of cryptographic elements based on real-time entropy conditions, access to protected data or operations may remain infeasible even if encrypted data, keys, or metadata are exposed, absent satisfaction of the required entropy-conditioned gating criteria.

The present disclosure is distinct from systems that rely on biometric identification, authentication, or template matching. The biometric signal may not be used to identify a user, but may instead be used as a transient input that gates whether one or more operations may occur.

The present disclosure relies exclusively on transient, non-identifying entropy fingerprints derived from biometric signals, without the storage, reuse, or modeling of biometric templates.

The system enables any type of encryption algorithm, including but not limited to, information-theoretic (e.g. one-time pad or OTP) or complexity-theoretic (e.g. post-quantum cryptography or PQC) depending on the data's sensitivity requirements. Additionally, zero-trust architecture ensures all cryptographic operations, including reconstruction key validation, biometric sensing component integrity checks, and entropy freshness may be enforced at every layer, preventing replay or impersonation attacks.

This present disclosure explicitly avoids persistent biometric identity tracking, relies on non-deterministic entropy sources, and gates access dynamically based on transient biometric responses and session-specific validation criteria. As a result, the present disclosure provides a secure, privacy-preserving, biometric-gated system with resilience that exceeds conventional biometric encryption architectures.

Although biometric signals comprising transient physiological responses are inherently non-reproducible in a strict cryptographic sense, the system allows for repeated stimuli to generate sufficiently similar entropy fingerprints to satisfy threshold-based validation. For example, viewing the same image twice may yield biometric-derived entropy fingerprints with shared statistical features, such as frequency-domain characteristics or coherence metrics, that are close enough to satisfy entropy-conditioned gating criteria for activation or use of one or more cryptographic or computational elements. This enables real-world use of stimulus-gated encryption/decryption cycles without requiring deterministic reproduction or persistent biometric templates.

In some embodiments, a biometric signal comprising one or more transient physiological responses may be elicited by a cognitive or sensory stimulus, such as a visual image, auditory tone, or symbolic pattern. The stimulus may be dynamically generated or varied on a per-session basis to produce a non-deterministic biometric response. This enables stimulus-linked entropy-conditioned gating without storing persistent biometric templates. Biometric signals generated in response to such stimuli may be used to condition or gate usability of elements derived from one or more entropy sources, influencing whether one or more cryptographic or computational operations may occur. Such biometric signals may control usability or activation of cryptographic or computational elements without serving as a deterministic source of entropy for generating such elements.

While the present disclosure may utilize biometric signals comprising transient physiological responses to condition, filter, or gate usability of elements derived from one or more non-deterministic entropy sources, it may not rely on deterministic derivation of cryptographic keys from such biometric signals alone. Such physiological response signals may be used as transient inputs to influence usability, activation, or reconstruction of one or more cryptographic or computational elements, rather than serving as a reproducible source of key material. Accordingly, the present disclosure may operate on the principle of entropy-conditioned gating, rather than deterministic biometric key derivation, and is structurally and functionally distinct from biometric encryption architectures that derive keys directly from biometric signals.

The present disclosure may operate without storing biometric templates or requiring identification or authentication of a user through biometric pattern recognition. Biometric signals comprising transient physiological responses may be used as real-time, non-deterministic inputs that may gate one or more cryptographic or computational operations without linkage to persistent identity, behavioral profiling, or classification models. As such, the present disclosure does not utilize biometric classification, behavioral modeling, or identity matching for secure access. In some embodiments, access control may be enforced based on satisfaction of one or more entropy-conditioned gating criteria derived from transient biometric signals.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components.

In some instances, a sub-label is associated with a reference numeral to denote one of multiple similar components. When reference is made to a reference numeral without specification to an existing sub-label, it is intended to refer to all such multiple similar components.

FIG. 1 illustrates a method for entropy-conditioned gating of cryptographic operations using a biometric signal comprising one or more transient physiological responses.

FIG. 2 illustrates a system architecture for entropy-conditioned gating of one or more cryptographic or computational operations using a biometric signal comprising one or more transient physiological responses.

FIG. 3 illustrates a method for evaluating one or more entropy-conditioned gating criteria using a biometric signal comprising one or more transient physiological responses.

### DEFINITIONS

The term “biometric signals” may include, but are not limited to, live signals obtained from pupillometry, electroencephalography (EEG), or other physiological sensing techniques. A biometric signal may comprise a transient physiological response, including, but not limited to, pupillometry-derived ocular responses, EEG-derived neural activity, or other physiological signal types. Such signals may be processed to derive one or more transient entropy fingerprints that are used to condition or gate usability of one or more cryptographic or computational elements. In certain embodiments, a biometric signal may be evaluated to determine whether entropy-conditioned gating criteria are satisfied, without requiring deterministic reproduction of a biometric signal. Biometric signals do not generate entropy or cryptographic keys and are not used as a deterministic source of entropy, but instead gate usability, activation, or execution of one or more cryptographic or computational elements derived from one or more non-deterministic entropy sources.

The term “biometric sensing components” may refer to components configured to acquire a biometric signal comprising one or more transient physiological responses. Such components may include, but are not limited to, pupillometry sensors, eye-tracking systems, electroencephalography (EEG) sensors, or other physiological signal acquisition systems, whether integrated within a user device, communicatively coupled to the system, or implemented as part of a distributed sensing architecture.

The term “complexity-theoretic security” may include a cryptographic assurance that a system remains secure based on the computational infeasibility of solving the underlying mathematical problem within polynomial time.

EEG: See electroencephalography.

The term “electroencephalography” may include measurement of neural electrical activity, including but not limited to frequency-domain signals, amplitude variations, phase relationships, coherence metrics, or time-series brainwave patterns elicited by cognitive, sensory, or memory-linked stimuli. EEG signals may be captured using one or more sensors and processed to derive one or more characteristics or entropy fingerprints. In the present system, EEG is used as a transient gating input for conditioning, gating, or influencing usability, activation, or execution of one or more cryptographic or computational operations. No raw EEG signals, identity templates, or persistent neural profiles are stored.

The term “entropy” may include any form of unpredictability introduced into a system via quantum, physical, or environmental randomness. Entropy sources may be derived from non-deterministic sources, wherein usability of elements derived from such entropy may be conditioned, filtered, or gated by a biometric signal comprising one or more transient physiological responses.

The term “Hamming distance” may refer to the number of positions at which the corresponding elements (typically bits) in two equal-length strings differ. It is a metric used to measure the dissimilarity between two binary sequences. In the context of the present disclosure, Hamming distance may be applied to compare transient entropy fingerprints derived from a biometric signal comprising one or more transient physiological responses, where a lower Hamming distance indicates a higher degree of similarity between biometric-derived entropy vectors. Threshold-based validation using Hamming distance enables fuzzy entropy matching without requiring exact signal replication, which may be used to evaluate one or more entropy-conditioned gating criteria.

The term “information-theoretic security” may include a cryptographic guarantee that a system remains secure regardless of an attacker's computational power, because the ciphertext reveals no information about the plaintext without the key.

The term “metadata” may include any classical or quantum-derived structure that encodes information about entropy characteristics, gating conditions, validation criteria, operation control parameters, or system state. This may include, but is not limited to, JSON, DAGs, blockchain hashes, compressed formats, or other data structures, excluding persistent biometric identity templates, and any future-compatible structure capable of recording entropy-related or operation-related attributes, including information that may be used to evaluate whether one or more entropy-conditioned gating criteria are satisfied.

The term “PQC” may include any post-quantum cryptography.

The term “pupillometry” may include measurement of ocular responses such as pupil dilation, constriction, blink rate, saccade latency, gaze direction, or eye movement patterns elicited by symbolic, cognitive, emotional, visual, auditory, tactile, or memory-linked stimuli. These responses are optically captured and digitally processed in real time using eye-tracking sensors or near-infrared illumination. In the present system, pupillometry is used as a non-deterministic gating input for conditioning, gating, or influencing usability, activation, or execution of one or more cryptographic or computational operations, including but not limited to decryption, data access, reconstruction, or execution of computational processes. No raw images, biometric identity templates, or pattern models are stored.

The term “QRNG” may include hardware that generates random (e.g. entropic) binary strings. True randomness or entropy can only be achieved through physical hardware due to the deterministic nature of mathematical functions or software algorithms, which can never be truly random or entropic. Quantum security cannot be achieved without a physical source of entropy and cannot be measured by statistical analysis. Entropy is a description of a physical phenomenon not a property of a number of sequences. Simulated entropy sources, even if statistically random, may not satisfy the requirements for QRNG-seeded processes as defined herein.

Quantum Random Number Generator: See QRNG.

The term “randomness” may include the lack of any predictable pattern or structure in a sequence of values, ensuring that each outcome is independent and unbiased, critical for secure encryption, key generation, and system unpredictability.

The term “reconstruction key” may include any encoded structure, cryptographic, structural, biometric, or behavioral, that enables, conditions, or governs the activation, access, or execution of one or more operations, including but not limited to decryption, data access, or computational execution. This may include identifiers, hashes, coordinates, or other control parameters, stored in classical or quantum-compatible format, wherein usability of such reconstruction key may be gated based on satisfaction of one or more entropy-conditioned gating criteria.

### DETAILED DESCRIPTION

The present disclosure provides a system that may integrate one or more entropy sources and a biometric signal comprising one or more transient physiological responses as gating inputs for one or more cryptographic or computational operations. The following detailed description outlines representative process flows in one or more operational modes.

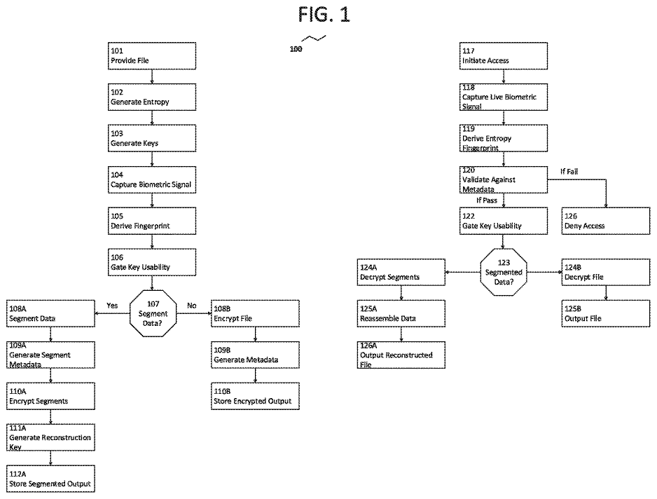

Referring to FIG. 1, a method is illustrated for entropy-conditioned gating of cryptographic operations using a biometric signal comprising one or more transient physiological responses. The method may include an encryption path and a decryption path, each governed by one or more entropy-conditioned gating criteria.

In the encryption path, a user may provide a file for encryption at 101. The system may obtain entropy from one or more non-deterministic entropy sources, including a Quantum Random Number Generator (QRNG), at 102. One or more cryptographic keys or cryptographic elements may be generated based on such entropy at 103.

A biometric signal may be captured at 104 using one or more biometric sensing components configured to acquire a biometric signal comprising one or more transient physiological responses. Such components may include, but are not limited to, pupillometry sensors, eye-tracking systems, electroencephalography (EEG) sensors, or other physiological signal acquisition systems, whether integrated within a user device, communicatively coupled to the system, or implemented as part of a distributed sensing architecture. The biometric signal may comprise one or more transient physiological responses elicited by a stimulus perceived or recalled by the user. The system may derive a transient entropy fingerprint from the biometric signal at 105. The system may not store the raw biometric signal and may instead retain only derived metadata.

A transient entropy fingerprint derived from the biometric signal may be used to condition or gate usability of one or more cryptographic or computational elements at 106. In certain embodiments, such elements may be generated independently of the biometric signal, and the biometric signal may control whether such elements may be used.

At 107, the system may determine whether data segmentation is to be performed. If segmentation is not performed, the system may encrypt the file at 108B using one or more cryptographic keys. Metadata describing the encrypted data may be generated at 109B, and the encrypted output may be stored at 110B.

If segmentation is performed, the system may segment the data into subfragments at 108A. Segment metadata describing structure, ordering, or validation logic may be generated at 109A. The system may encrypt the segments at 110A. A reconstruction key may be generated at 111A to enable reassembly of the segmented data. The segmented output may then be stored at 112A.

In the decryption path, a user may initiate access to the encrypted file at 117. A live biometric signal comprising one or more transient physiological responses may be captured at 118. The system may derive a new transient entropy fingerprint at 119.

The system may validate the new entropy fingerprint against stored biometric signal metadata at 120. Validation may include comparison of entropy characteristics or evaluation of one or more entropy-conditioned gating criteria. If validation fails, the system may deny access at 126, and no decryption or reconstruction may occur.

If validation succeeds, the system may enable or gate usability of one or more cryptographic keys at 122, allowing subsequent operations to proceed.

At 123, the system may determine whether the stored data is segmented. If the data is not segmented, the system may decrypt the file at 124B and output a restored file at 125B.

If the data is segmented, the system may decrypt one or more segments at 124A, reassemble the data using metadata and the reconstruction key at 125A, and output a restored file at 126A.

In certain embodiments, possession of encrypted data, metadata, or cryptographic elements alone may be insufficient to permit decryption or reconstruction. Usability of such elements may remain conditioned on satisfaction of the entropy-conditioned gating criteria derived from a live biometric signal. Accordingly, attempts to access or reconstruct data without a valid biometric signal may be denied, thereby preventing unauthorized use even in scenarios involving data exfiltration.

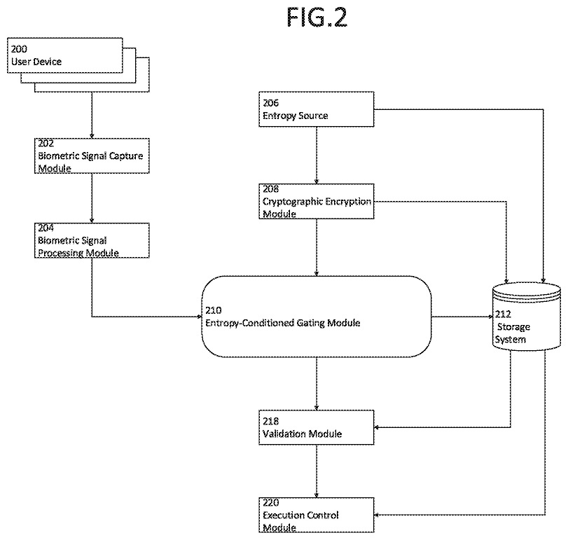

Referring to FIG. 2, a system architecture is illustrated for entropy-conditioned gating of one or more cryptographic or computational operations using a biometric signal comprising one or more transient physiological responses. The system may include one or more devices, modules, or components configured to capture biometric signals, obtain entropy, generate cryptographic elements, store data and metadata, and control execution of one or more operations based on satisfaction of one or more entropy-conditioned gating criteria.

A user device 200 may be configured to interface with one or more system components and may include or be communicatively coupled to a biometric signal capture module 202. The biometric signal capture module 202 may be configured to acquire a biometric signal comprising one or more transient physiological responses, including but not limited to pupillary dilation, blink rate, saccade latency, brainwave activity, frequency-domain characteristics, and other physiological response metrics. The captured biometric signal may be transmitted to a biometric signal processing module 204.

The biometric signal processing module 204 may be configured to process the biometric signal and derive one or more characteristics or a transient entropy fingerprint. The module may extract one or more statistical, temporal, or spectral features from the biometric signal. In certain embodiments, the system may not store the raw biometric signal and may instead store only derived metadata describing such characteristics.

An entropy source 206 may be configured to provide entropy from one or more non-deterministic sources, including but not limited to a QRNG. The entropy source 206 may supply entropy to a cryptographic encryption module 208.

The cryptographic encryption module 208 may be configured to generate one or more cryptographic or computational elements, including elements used for data protection or execution control. Such elements may be derived from entropy provided by the entropy source 206 and may be generated independently of the biometric signal. In certain embodiments, generation of one or more cryptographic or computational elements may include one or more derivation or transformation functions to entropy obtained from one or more non-deterministic entropy sources, optionally using one or more context parameters, salts, or domain-separation inputs, wherein such generation remains independent of the biometric signal.

An entropy-conditioned gating module 210 may be configured to condition, filter, or gate usability of one or more cryptographic or computational elements based on one or more characteristics derived from the biometric signal. The entropy-conditioned gating module 210 may enforce one or more entropy-conditioned gating criteria that determine whether one or more such elements may be activated, accessed, or used.

A storage system 212 may be configured to store metadata describing entropy characteristics, validation criteria, or other information used to evaluate entropy-conditioned gating conditions, as well as one or more encrypted data objects. The metadata may exclude raw biometric signals or identity templates and may be structured to enable comparison without enabling reconstruction of the biometric signal. In some embodiments, the encrypted data may be segmented or structured, and such segmentation may be reflected in associated metadata. In certain embodiments, one or more reconstruction keys may be stored within the storage system 212, wherein usability of such reconstruction keys may be gated based on satisfaction of one or more entropy-conditioned gating criteria. In certain embodiments, one or more such artifacts may be transiently retained, maintained in memory, distributed across one or more systems, recomputed on demand, or not stored, such that persistent storage of any particular artifact is not required.

A validation module 218 may be configured to evaluate one or more entropy-conditioned gating criteria by comparing a live-derived entropy fingerprint to stored metadata. The validation module 218 may determine whether one or more similarity thresholds or validation conditions are satisfied.

An execution control module 220 may be configured to permit or deny execution of one or more operations based on the output of the validation module 218 and, in some embodiments, information retrieved from the storage system 212. Such operations may include, but are not limited to, encryption, decryption, data access, reconstruction, transformation, or execution of one or more computational processes. If the entropy-conditioned gating criteria are not satisfied, the execution control module 220 may deny the requested operation.

In certain embodiments, the system architecture illustrated in FIG. 2 may operate under a zero-trust model in which all inputs, including biometric signals, entropy sources, and metadata, may be validated prior to permitting any operation. Possession of encrypted data, cryptographic elements, or metadata alone may be insufficient to permit execution absent satisfaction of the required entropy-conditioned gating criteria derived from a live biometric signal.

In certain embodiments, satisfaction of the entropy-conditioned gating criteria may be required before activation of one or more cryptographic or computational capabilities, such that decryption, reconstruction, access, or execution may not occur unless a live biometric signal comprising one or more transient physiological responses satisfies the required gating condition.

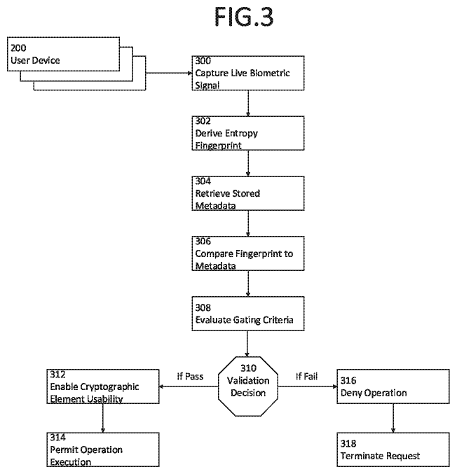

Referring to FIG. 3, a method is illustrated for evaluating one or more entropy-conditioned gating criteria using a biometric signal comprising one or more transient physiological responses. The method may determine whether one or more cryptographic or computational elements may be activated or used.

A live biometric signal may be captured at 300. The biometric signal may comprise one or more transient physiological responses, including but not limited to pupillary dilation, blink rate, saccade latency, brainwave activity, frequency-domain characteristics, and other physiological response metrics. The biometric signal may be acquired in real time using one or more biometric sensing components.

The system may derive one or more characteristics or a transient entropy fingerprint from the biometric signal at 302. The entropy fingerprint may include one or more statistical, temporal, or spectral features extracted from the biometric signal.

In certain embodiments, the system may retrieve stored metadata at 304. The metadata may include one or more entropy characteristics, validation parameters, or gating criteria associated with a prior operation. In other embodiments, the system may operate without retrieval of stored metadata.

The system may compare the derived entropy fingerprint to the stored metadata at 306. The comparison may evaluate similarity or congruence between one or more entropy characteristics.

At 308, the system may evaluate one or more entropy-conditioned gating criteria. Such criteria may include one or more similarity thresholds, statistical conditions, or validation parameters. Evaluation may be performed using one or more methods, including Hamming distance, cosine similarity, spectral coherence, or other mathematical models.

At 310, the system may determine whether the entropy-conditioned gating criteria are satisfied. If the criteria are satisfied, the system may enable usability of one or more cryptographic or computational elements at 312 and permit execution of one or more operations at 314.

If the entropy-conditioned gating criteria are not satisfied, the system may deny the requested operation at 316 and terminate the request at 318.

In certain embodiments, the method illustrated in FIG. 3 may operate independently or in conjunction with one or more system components described in FIG. 1 and FIG. 2. The method may be applied to control access to encrypted data, reconstruction processes, or execution of one or more computational operations, and may enforce that usability of such operations is conditioned on a live biometric signal rather than possession of data or cryptographic elements alone.

Step 1—Biometric Signal Acquisition: One or more biometric sensing components may capture real-time physiological responses from a user, including but not limited to ocular responses and/or neural responses, such as pupil dilation, constriction, blink rate, saccade latency, gaze fixation dynamics, brainwave activity, frequency-domain characteristics, or other neural signal features. These responses may be elicited by symbolic, cognitive, or affective stimuli that may trigger non-deterministic physiological responses. The biometric signal may comprise one or more transient physiological features and may be digitized and segmented into time windows. Entropy-relevant metrics such as response latency, amplitude dynamics, temporal variation, coherence characteristics, or modality-specific features may be extracted and used to derive an entropy fingerprint. The stimulus may be dynamically generated or varied on a per-session basis to produce a non-deterministic biometric response that may be used for entropy-conditioned gating.

Step 2—Entropy Retrieval: A quantum random number generator (QRNG) or other non-deterministic source of entropy may provide an entropy stream.

Step 3—Entropy Conditioning & Gating: One or more features derived from the biometric signal comprising one or more transient physiological responses may be used to condition, filter, or gate usability of one or more elements derived from the entropy stream. Such conditioning may introduce session-specific variability and may be used to determine whether one or more operations may be permitted.

Step 4—Cryptographic or Computational Element Derivation: One or more cryptographic or computational elements, including but not limited to keys, tokens, or control parameters, may be derived from entropy obtained from one or more non-deterministic entropy sources, wherein usability of such elements may be conditioned or gated by the biometric signal.

Step 5—Optional Mode Selection: The system may operate in one or more modes, including classical, quantum, or hybrid quantum-classical modes. Mode selection may depend on system configuration, data sensitivity, availability of quantum resources, or other criteria. The system is operable in both classical and hybrid quantum-classical computing environments. In classical systems, entropy may flow from hardware QRNGs or other non-deterministic entropy sources through conditioning layers whose outputs may be subject to biometric gating. In hybrid implementations, quantum gates may perform intermediate transformations on superpositioned and entangled data representations. All models may follow zero-trust security principles and reject entropy reuse, replay attacks, or behavioral biometric modeling.

Step 6—Quantum or Classical Transformation (Optional): In some embodiments, one or more transformation processes may be applied to data, entropy, or computational states. Such processes may include classical transformations or quantum operations. Where quantum operations are used, one or more quantum gates may be applied to qubits representing entropy states or computational inputs. The biometric signal may condition or gate usability of outputs or elements derived from such transformations.

Step 7—Measurement or Output Generation (Optional): In embodiments involving quantum processing, one or more measurement operations may be performed to convert quantum states into classical outputs. The resulting outputs may be used as inputs for downstream operations, wherein usability of such outputs may be subject to one or more entropy-conditioned gating criteria.

Step 8—Operation Request and Preliminary Evaluation: A request may be made to perform one or more operations, including but not limited to decryption, data access, reconstruction, transformation, or execution of computational processes. The system may perform a preliminary evaluation to determine whether such operation may proceed to entropy-conditioned gating based on one or more high-level criteria, including system state, metadata availability, or policy conditions.

Step 9—Live Biometric Signal Acquisition for Gating: A live biometric signal comprising one or more transient physiological responses may be captured and processed to derive an entropy fingerprint. The entropy fingerprint may represent one or more statistical, temporal, or spectral characteristics of the biometric signal.

Step 10—Entropy-Conditioned Validation: The system may evaluate one or more entropy-conditioned gating criteria, which may include comparison of the derived entropy fingerprint to stored metadata, evaluation of statistical similarity metrics, entropy validation checks, or other criteria. This step may determine whether the request is eligible to proceed to a subsequent, operation-specific validation process. Validation may be performed using one or more methods, including Hamming distance, cosine similarity, spectral coherence, or other mathematical models.

Step 11—Conditional Operation Enablement: If one or more preliminary entropy-conditioned gating criteria are satisfied, the system may permit the requested operation to proceed to an operation-specific gating process. If such criteria are not satisfied, the system may deny the request.

Step 12—Operation Preparation: Upon successful validation, the system may prepare one or more cryptographic or computational elements required to perform the requested operation, including but not limited to decryption, data access, reconstruction, transformation, or execution of computational processes. The system may establish one or more conditions, states, or contexts under which the requested operation may be executed, including readiness of data, computational resources, or cryptographic elements.

Step 13—Decryption or Access Request Initiation: A user or system may request execution of one or more operations, including but not limited to decryption, data access, reconstruction, or execution of a computational process. The system may retrieve one or more data objects, cryptographic elements, or associated metadata required to evaluate the request.

Step 14—Live Biometric Signal Acquisition: The user may provide a live biometric signal comprising one or more transient physiological responses, such as pupillary dilation, blink rate, saccade latency, brainwave activity, frequency-domain characteristics, and other physiological response metrics. This real-time signal may be processed into features representing one or more statistical, temporal, or spectral characteristics of the biometric signal.

Step 15—Entropy-Conditioned Validation: The system may perform one or more validation processes to determine whether the requested operation may be permitted. Such validation may include one or more of: (i) entropy integrity checks applied to elements derived from one or more entropy sources; (ii) metadata-bound validation; (iii) comparison of characteristics derived from a real-time biometric signal to stored reference characteristics; or (iv) evaluation of one or more entropy-conditioned gating criteria. Validation may utilize one or more similarity metrics, including Hamming distance, cosine similarity, spectral coherence, or other mathematical models. In some embodiments, validation may be performed using privacy-preserving methods, including zero-knowledge proofs.

Step 16—Conditional Enablement of Cryptographic or Computational Elements: If one or more entropy-conditioned gating criteria are satisfied, the system may enable access to, or activation of, one or more cryptographic or computational elements required to perform the requested operation. If such criteria are not satisfied, the system may deny the operation.

Step 17—Decryption and/or Reconstruction Execution: Upon successful validation, the system may execute one or more operations, including but not limited to decryption of encrypted data, reconstruction or reassembly of data or data structures, transformation of data, or execution of computational processes. Such operations may utilize one or more elements derived from one or more non-deterministic entropy sources, wherein usability of such elements is conditioned or gated by the biometric signal. If the biometric signal comprising one or more transient physiological responses is stale, replayed, or fails to satisfy the required validation criteria, reconstruction may be denied. No partial reassembly or data leakage may occur, ensuring that decryption is strictly gated by live, session-specific biometric input.

Step 18—Output Restoration or Access: Following execution, the system may provide access to the resulting data, restore one or more data objects to a usable state, or permit continuation of one or more computational processes. The output may be made available only within the context of the validated session.

Step 19—Security Enforcement: The system may enforce security by ensuring that operations may not occur unless required entropy-conditioned gating criteria are satisfied. Possession of data, cryptographic elements, or metadata alone may be insufficient to enable operation without satisfaction of such criteria.

Step 20—Replay and Integrity Protection: The system may detect and reject replayed, stale, or invalid biometric signals based on entropy mismatch, statistical divergence, or failure to satisfy gating criteria. No partial execution or data exposure may occur when validation fails.

Step 21—Zero-Trust Operation: The system may operate under a zero-trust model in which all inputs, including entropy sources, biometric signals, and metadata, may be validated prior to permitting any operation.

Step 22—Entropy Variability and Usability: The system may permit operation based on similarity of entropy characteristics rather than exact reproduction of biometric signals. Variability in biometric signals may be tolerated within defined thresholds, enabling practical usability while maintaining security.

Step 23—Multi-User and Group-Based Access (Optional): In some embodiments, multiple users may be permitted to perform operations based on satisfaction of one or more entropy-conditioned gating criteria. Each user may provide a live biometric signal that is evaluated independently against stored entropy characteristics or validation criteria.

Step 24—Security Guarantees: The system may provide security in scenarios where an adversary obtains access to data, metadata, or cryptographic elements. Without satisfaction of required entropy-conditioned gating criteria derived from a live biometric signal, such access may not enable execution of protected operations.

Step 25—Key Theft Immunity: Even if an adversary obtains a full copy of the encrypted data, associated encryption keys, and reconstruction metadata, they cannot decrypt or reconstruct the original content without satisfaction of the required entropy-conditioned gating criteria derived from a live biometric signal. Stored keys or metadata alone are insufficient for access, rendering exfiltrated data unusable without a valid transient entropy fingerprint derived from such biometric signal.

In further embodiments, the system may employ a fuzzy validation layer that compares a biometric-derived entropy fingerprint from a live biometric signal to one or more reference characteristics derived during the encryption session. This comparison may tolerate minor variability in the biometric response, including timing jitter, frequency-domain variation, and waveform distortion, so long as the derived fingerprint satisfies one or more similarity thresholds using cosine similarity, Hamming distance, cross-spectral coherence metrics, or other mathematical methods or models. Such comparison may occur in the time, frequency, or time-frequency domain, enabling decryption when the biometric signal is functionally similar but not identical to the original biometric signal. This enables real-world usability for stimulus-gated encryption cycles under normal physiological variability. The biometric signal thus provides a transient entropy fingerprint used to satisfy one or more entropy-conditioned gating criteria required for decryption (e.g., if the live signal sufficiently satisfies such criteria, decryption may be permitted). In certain embodiments, evaluation of one or more entropy-conditioned gating criteria may include comparing one or more characteristics derived from a live biometric signal to one or more stored or reference characteristics.

The comparison may determine whether the live-derived entropy characteristics sufficiently correspond to the reference entropy characteristics to satisfy one or more predefined or dynamically determined gating conditions. Such conditions may include thresholds, ranges, or other criteria defining acceptable levels of similarity, congruence, or compatibility. In certain embodiments, the evaluation may tolerate variation in the biometric signal while maintaining resistance to replay, spoofing, or non-corresponding inputs.

Evaluation of entropy-conditioned gating criteria may be performed using any suitable computational technique, model, or method, including but not limited to distance-based, correlation-based, probabilistic, or transformation-based approaches. The specific technique used is not limiting, and the system may operate independently of any particular mathematical formulation, algorithm, or implementation.

The present disclosure does not perform biometric authentication in the form of persistent identity recognition, behavioral modeling, or biometric pattern classification. The system does not store biometric signals in raw, structured, or template form, nor does it apply machine learning, biometric templates, or classification algorithms to identify or verify users. Instead, biometric signals comprising one or more transient physiological responses may be transiently sampled and used exclusively to condition or gate usability of one or more cryptographic or computational elements on a per-session basis. This architecture may operate under a stochastic validation model and avoids deterministic or identity-based processing.

In real-world usage, the present system enables a user to access data that was previously protected, even though biometric signals are inherently variable and not stored. This is achieved not through biometric identity recognition, but via transient entropy fingerprint similarity. During protection of the data, the user's biometric signal may be sampled in real time and used to condition or gate usability of elements derived from one or more non-deterministic entropy sources, without deterministically generating cryptographic or computational elements from the biometric signal itself. This results in a session-specific transient entropy fingerprint that governs whether one or more cryptographic or computational elements may be used.

Upon decryption, the user may provide a live biometric signal under similar cognitive or environmental conditions (e.g., viewing the same visual or auditory stimulus). Although the new biometric signal may differ in fine-grained waveform details, it may generate a transient entropy fingerprint that is statistically similar to the original within a predefined similarity threshold. These thresholds may be evaluated using cosine similarity, Hamming distance, spectral coherence, or other mathematical methods or models.

If the new transient entropy fingerprint passes the threshold test, the system may permit access to or activation of one or more cryptographic or computational elements and allow execution of the requested operation. This fuzzy entropy matching strategy permits legitimate reuse by the same user, while remaining secure against mismatched entropy inputs. Importantly, no persistent biometric templates are stored, reused, or compared. The system does not rely on biometric identity modeling, behavioral profiling, or classification techniques for access control. Instead, access is governed by entropy congruency between the live biometric signal and session-derived entropy metadata. Possession of cryptographic elements, entropy sources, or metadata alone may be insufficient to enable use of such elements without satisfaction of the entropy-conditioned gating criteria derived from the live biometric signal.

This entropy-congruency model supports reproducible encryption/decryption cycles for the same user without relying on exact biometric replication or deterministic biometric behavior, and ensures that even with session variability, authorized users can regain access without compromising privacy or security.

This system provides a zero-trust architecture that ensures forward secrecy and real-time gating of usability. Even in the event of full compromise, including exposure of a full copy of encrypted data, metadata, encryption keys, and/or reconstruction keys, no decryption is possible without satisfaction of the required entropy-conditioned gating criteria derived from a live biometric signal. The system does not store biometric signals or biometric templates, making recovery of transient entropy fingerprints infeasible. Decryption validation is conditioned on transient, non-reproducible biometric-derived fingerprints rather than identity, making the system resilient to spoofing, cloning, or replay-based attacks.

It is important to distinguish between an adversary obtaining a copy of encrypted data and associated cryptographic elements versus obtaining the only existing instance. The system provides strong cryptographic protection in scenarios where an attacker gains unauthorized access to a duplicate of the protected materials (e.g., decryption will still fail without satisfaction of the required entropy-conditioned gating criteria derived from a live biometric signal). However, if the adversary obtains the sole copy of the encrypted assets and denies access to the authorized user, recovery may become infeasible, not due to cryptographic failure, but due to loss of availability. Accordingly, while the system preserves data confidentiality even under adversarial duplication, it is recommended that operational deployments include secure storage replication, multi-location backups, and controlled re-acquisition of biometric signals (e.g., using repeatable or dynamically generated stimuli) to preserve data accessibility for a legitimate user without compromising non-deterministic behavior or violating identity-free design principles.

In alternative embodiments, the system may support group-based or one-to-many biometric validation, wherein a single encrypted asset may be accessed by multiple authorized users. During the encryption process, a primary biometric-derived entropy fingerprint may be used to gate usability of one or more cryptographic elements, as described previously. However, instead of encoding a one-to-one decryption path, the system may additionally encode a set of validation criteria or thresholds associated with a group of secondary users.

Each authorized user may supply their own live biometric signal, which is independently evaluated against metadata associated with the original encryption event. The system does not store biometric profiles or identities, but rather compares entropy fingerprints derived from biometric signals for statistical similarity, overlap, or satisfaction of one or more threshold-based criteria. Such evaluation may be associated with shared stimuli (e.g., symbolic image, tone, or memory cue) or with tolerance conditions defined over one or more derived feature domains.

Reconstruction keys, if used, may encode multiple validation paths, allowing decryption by any user whose live biometric signal satisfies at least one set of entropy-conditioned gating criteria. This enables secure group access without identity modeling or biometric storage, and preserves the system's resistance to spoofing, replay, and impersonation attacks.

What is claimed is:

1. A method comprising:
receiving, by a system, a biometric signal comprising one or more transient physiological responses;
deriving one or more characteristics from the biometric signal;
obtaining entropy from one or more non-deterministic entropy sources;
conditioning or gating usability of one or more cryptographic or computational elements derived from the entropy using the characteristics;
evaluating one or more entropy-conditioned gating criteria based on the biometric signal and stored metadata; and
permitting or denying execution of one or more operations based on whether the entropy-conditioned gating criteria are satisfied,
wherein one or more operations comprise decryption, data access, reconstruction, transformation, or execution of a computational process.

2. A method comprising:
obtaining entropy from a non-deterministic entropy source;
receiving a biometric signal comprising one or more transient physiological responses;
deriving one or more characteristics from the biometric signal;
generating one or more cryptographic or computational elements based on the entropy;
encrypting data using one or more cryptographic elements; and
gating usability of the one or more cryptographic elements based on satisfaction of one or more entropy-conditioned gating criteria derived from a subsequent biometric signal.

3. A system comprising:
a biometric capture module configured to acquire a biometric signal comprising one or more transient physiological responses;
an entropy module configured to obtain entropy from one or more non-deterministic entropy sources;
a conditioning module configured to derive one or more characteristics from the biometric signal and condition or gate usability of one or more cryptographic or computational elements derived from the entropy;
a validation module configured to evaluate one or more entropy-conditioned gating criteria based on the biometric signal and stored metadata; and
an execution control module configured to permit or deny execution of one or more operations based on the evaluation,
wherein the one or more operations comprise decryption, data access, reconstruction, transformation, or execution of a computational process.

4. The method of claim 1, wherein the biometric signal is not stored in raw form.

5. The method of claim 1, wherein the stored metadata comprises entropy characteristics that are non-invertible.

6. The method of claim 1, wherein the biometric signal is acquired in real time.

7. The method of claim 1, wherein the entropy-conditioned gating criteria comprise threshold-based similarity evaluation.

8. The method of claim 1, wherein similarity is evaluated using one or more of Hamming distance, cosine similarity, spectral coherence, or other metric.

9. The method of claim 1, wherein the biometric signal is elicited by a stimulus.

10. The method of claim 1, wherein the stimulus is dynamically generated or varied per session.

11. The method of claim 1, wherein execution is denied if the biometric signal is stale or replayed.

12. The method of claim 2, wherein the cryptographic elements comprise encryption keys.

13. The method of claim 2, wherein the cryptographic elements are not deterministically derived from the biometric signal alone.

14. The method of claim 2, wherein the gating requires a subsequent biometric signal captured during an access attempt.

15. The method of claim 2, wherein the data is optionally segmented prior to or after encryption.

16. The system of claim 3, wherein the entropy module comprises a non-deterministic entropy source.

17. The system of claim 3, wherein the validation module is configured to operate without storing biometric identity templates.

18. The system of claim 3, wherein possession of encrypted data and metadata alone is insufficient to permit execution without satisfaction of the entropy-conditioned gating criteria.

19. The system of claim 3, wherein the biometric capture module comprises a pupillometry device.

20. The system of claim 3, wherein the biometric capture module comprises an electroencephalography (EEG) device.
